(19) United States
(12) Patent Application Publication
(10) Pub. No.: US 2004/0046517 A1
(43) Pub. Date: Mar. 11, 2004

(54) Electric system of a vehicle

(76) Inventors: Jong-Dae Kim, Seoul (KR); Kwang-Yong Choi, Seoul (KR)

Correspondence Address: Pennie & Edmonds, LLP, 3300 Hillview Avenue, Palo Alto, CA, 94304, US

(21) Appl. No.: 10/331,225

(22) Filed: Dec. 30, 2002

(30) Foreign Application Priority Data
Sep. 5, 2002 (KR) 2002-0053515

(51) Int. Cl. H02P 1/00

(52) U.S. Cl. 318/139

(57) ABSTRACT

An electric system of a vehicle includes a motor-generator unit disposed between an engine and a transmission for selectively functioning as a motor for driving the engine, and as an electric generator driven by the engine. A control unit recharges a battery unit (of a voltage higher than 14V) by controlling output electric power of the motor-generator unit, and drives the motor-generator unit with electric power of the battery unit. The control unit counts a number of pulses sequentially received from a magnetic sensor for a predetermined period, and calculates a rotation speed of the motor-generator unit based at least in part a value obtained by dividing the number of the received pulses by the predetermined period.

### FIELD OF THE INVENTION

The present invention relates to an electric system of a vehicle, and more particularly, to an electric system of a vehicle for utilizing a voltage higher than the conventional 14V, and for determining rotational speed of a motor of the vehicle.

### BACKGROUND OF THE INVENTION

Recently, the number of electric components consuming electric power in vehicles has been increasing and, accordingly, strategies for supplying stable and sufficient electric power for such components are being considered. For example, raising the voltage used for such electric components has been proposed. However, to raise the voltage level of an electric vehicle, the electric systems used by the vehicle must also be modified.

A motor for an electric generator usually includes a stator and rotor. The stator and rotor, collectively referred to herein as a motor-generator unit, can be combined to selectively function as an electric generator when the motor-generator unit is being mechanically driven, or as a motor when being electrically driven, as is well-known in the art. A motor-generator unit functions more efficiently when the applied voltage is higher.

The information disclosed in this Background of the Invention section is only for enhancement of understanding of the background of the invention, and should not be taken as an acknowledgement or any form of suggestion that this information forms the prior art that is already known to a person skilled in the art.

### SUMMARY OF THE INVENTION

In a preferred embodiment, an electric system of a vehicle having an engine and a transmission includes: a battery unit, a motor-generator unit, and a control unit. The battery unit is of a voltage higher than 14V. The motor-generator unit, disposed between the engine and the transmission, is for selectively functioning as a motor for driving the engine, and as an electric generator driven by the engine. The control unit is for recharging the battery unit by controlling output electric power of the motor-generator unit, and for driving the motor-generator unit with electric power of the battery unit.

In another preferred embodiment, the battery unit further comprises a plurality of battery units, including at least one low-voltage battery unit and at least one high voltage battery unit. Low-voltage electric components of the vehicle receive power substantially from the at least one low-voltage battery unit, and high-voltage electric components of the vehicle receive power substantially from the at least one high-voltage battery unit.

In a further preferred embodiment of the present invention, the motor-generator unit includes: a stator fixed to the engine body, and a rotor fixed to at least one of a crankshaft of the engine and an input rotating element of the transmission. Preferably, the transmission is an automatic transmission equipped with a torque converter, and the input rotating element of the transmission is the torque converter.

In another further preferred embodiment of the present invention, the electric system of a vehicle further includes: a toothed wheel having a plurality of teeth and rotating with the rotor; and a magnetic sensor, fixed at a stationary portion of at least one of the engine and the transmission, for generating pulse signals corresponding to rotation of the toothed wheel. The control unit calculates rotation speed of the rotor based on signals from the magnetic sensor. Preferably, the plurality of teeth are formed on an exterior circumference of the toothed wheel, and the magnetic sensor is disposed to the exterior of the plurality of teeth with a predetermined gap therebetween. Also, preferably, the transmission is an automatic transmission equipped with a torque converter, and the toothed wheel preferably is disposed at a side of the torque converter toward the motor-generator unit. Additionally, preferably, the plurality of teeth preferably are configured in a resolution of approximately 3 degrees, and the distance between adjacent teeth of the plurality of teeth is preferably approximately 14 mm.

The control unit of a preferred embodiment of the present invention calculates a rotation speed of the motor-generator unit by counting a number of pulses sequentially received from the magnetic sensor for a predetermined period, and by subsequently calculating a rotation speed of the motor-generator unit based at least in part on a value obtained by dividing the number of the received pulses by the predetermined period.

In yet another preferred embodiment of the present invention, a method for determining the rotational speed of a motor in a vehicle is presented. The method includes driving a motor that rotates a rotor, the rotor including a toothed wheel having a plurality of teeth; generating pulses by magnetically sensing rotation of the plurality of teeth of the toothed wheel with a magnetic sensor, the magnetic sensor being fixed at a stationary portion of at least one the engine and a transmission; and calculating rotational speed of the motor, in a control unit, based at least part on the pulses from the magnetic sensor.

Preferably, the step of calculating rotational speed of the motor further comprises: counting a number of pulses sequentially received from the magnetic sensor for a predetermined period; and calculating a rotation speed of the motor based at least in part on a value obtained by dividing the number of the received pulses by the predetermined period.

Also, preferably, the transmission is an automatic transmission equipped with a torque converter, and the toothed wheel is disposed at a side of the torque converter toward the motor. In addition, the plurality of teeth preferably are configured in a resolution of approximately 3 degrees. The distance between adjacent teeth of said plurality of teeth is preferably approximately 14 mm.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic diagram of an electric system of a vehicle according to a preferred embodiment of the present invention;

FIG. 2 is an enlarged perspective view of portion A in FIG. 1; and

FIG. 3 is a flowchart showing a method for calculating rotation speed of a motor-generator unit according to a preferred embodiment of the present invention.

### DETAILED DESCRIPTION OF THE PREFERRED EMBODIMENTS

A preferred embodiment of the present invention will hereinafter be described in detail with reference to the accompanying drawings.

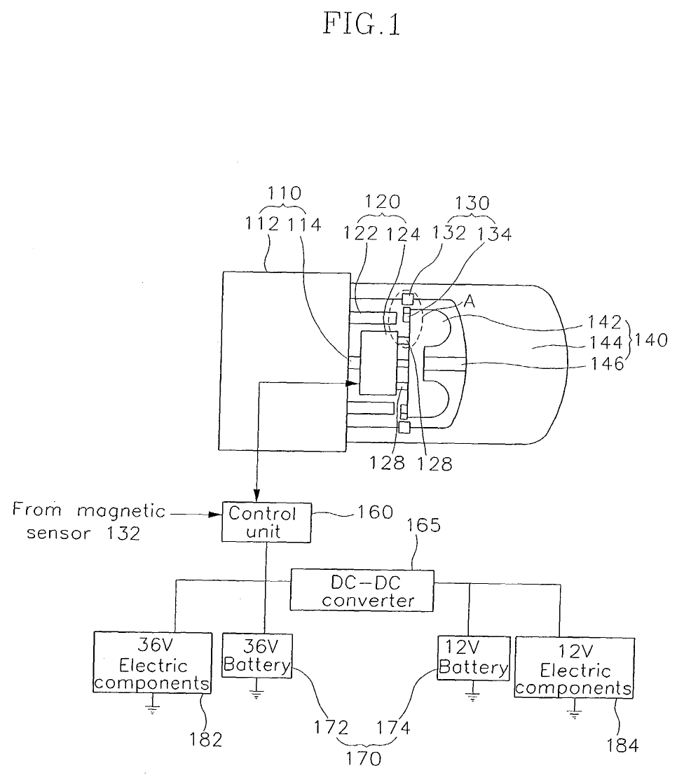

As shown in FIG. 1, the electric system includes a battery unit 170, a motor-generator unit 120, and a control unit 160. The battery unit 170 has a voltage higher than 14V. The motor-generator unit 120, disposed between an engine 110 and a transmission 140, is for selectively functioning as a motor for driving the engine 110, and as an electric generator driven by the engine 110. The control unit 160 is for recharging the battery unit 170 by controlling output electric power of the motor-generator unit 120, and for driving the motor-generator unit 120 by electric power of the battery unit 170.

Note that the transmission 140 can be a manual transmission or an automatic transmission equipped with a torque converter. However, preferably, the transmission 140 is hereinafter described as an automatic transmission equipped with a torque converter 142. The torque converter 142 is connected to a transmission input shaft 146 protruding from a transmission body 144 of the transmission 140.

For purposes of the description below, the expression “motor-generator unit” is hereinafter abbreviated as “IGS” (Integrated Generator and Starter). The word “Starter” abbreviated in “IGS” is adopted to note that the IGS 120 can function as a starter of the engine 110, but it should be understood that the scope of the motor-generator unit 120 is not limited to this embodiment.

More specifically, the IGS 120 includes a stator 122 and a rotor 124. The stator 122 is fixed to an engine body 112, and the rotor 124 is fixed to both a crankshaft 114 of the engine 110, and to an input rotating element, i.e., the torque converter 142 of the transmission 140. For example, as shown in FIG. 1, the rotor 124 is fixed to the crankshaft 114 on the left, and fixed to the torque converter 142 on the right by fixing members 128.

The battery unit 170 connected to the control unit 160 includes a 12V battery 174 connected to the control unit 160, and to an additional 36V battery 172, through a DC-DC converter 165. As described above, batteries of different voltages are separately included in the preferred embodiment of the present invention. Electric components 184 with small electric loads, for example, a radio and/or turn signals, are connected to the 12V battery 174. Components 182 with high electric loads are connected to the 36V battery 172. The high electric load components may include a compressor in an air conditioning system and/or a water pump of the engine 110, which are normally belt-driven, but can be changed to be electrically-driven.

The control unit 160 can be implemented as one or more processors activated by predetermined software, and the predetermined software can be programmed by a person of ordinary skill in the art to perform each step performed by the control unit 160 as described herein. The control unit 160 may also contain other necessary hardware and software components, as will be understood by persons skilled in the art, to permit the control unit to communicate with sensors and to execute the control function as described herein.

The control unit 160 starts the engine 110 by controlling the IGS 120 as a motor using electric power supplied from the batteries 172 and 174. When the engine 110 is running, the control unit 160 controls the IGS 120 as an electric generator, such that the batteries 172 and 174 are recharged by electric power generated by the IGS 120.

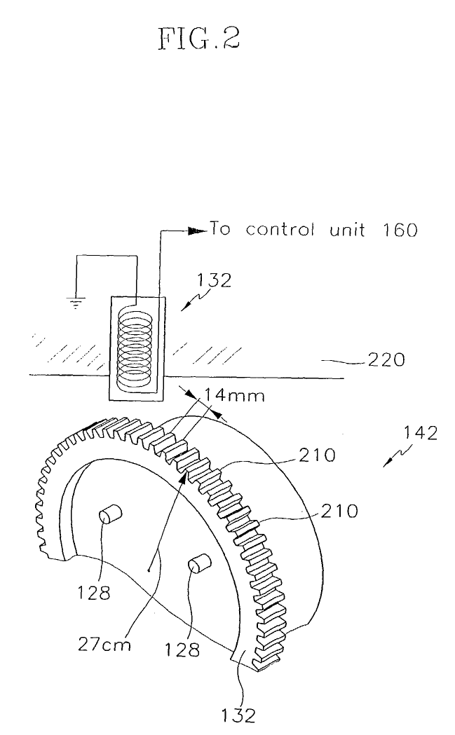

Additionally, the electric system of a vehicle according to a preferred embodiment of the present invention further includes a sensor unit 130 for detecting a rotation speed of the rotor 124. The sensor unit 130 includes: a toothed wheel 134 having a plurality of teeth 210 (shown in further detail in FIG. 2) and rotating with the rotor 124; and a magnetic sensor 132, fixed at a stationary portion of the engine 110 and/or the transmission 140, for generating pulse signals corresponding to rotation of the toothed wheel 134.

The control unit 160 calculates rotation speed of the rotor 124 based on signals received from the magnetic sensor 132. The rotation speed of the rotor 124 can be used for controlling the engine 110 and/or the IGS 120. For example, the rotation speed can be used as a parameter for controlling electric power generation of the IGS 120, and can be used as a precise measurement of engine speed, i.e., rotation speed of the crankshaft 114, because the rotor 124 is fixed thereto.

Referring now to FIG. 2, which is an enlarged perspective view of portion A of FIG. 1, mechanical features of the toothed wheel 134 and the magnetic sensor 132 are illustrated. The plurality of teeth 210 are formed on an exterior circumference of the toothed wheel 134, and the toothed wheel 134 is disposed at a distal end of a side of the torque converter 142, toward the IGS 120.

The magnetic sensor 132, which generates electric signals from magnetic interaction with the teeth 210, is fixed in a transmission housing 220 as an example of the stationary portion of the engine 110 and/or the transmission 140. The magnetic sensor 132 is disposed toward an exterior of the plurality of teeth 210, with a predetermined gap therebetween.

Specifications of the teeth 210, such as teeth distance, are implementation details that may be determined by a person skilled in the art. As an example, when the diameter of the torque converter 142 is about 27 cm, forming more than 120 teeth on the exterior circumference of the torque converter 142 is found to result in substantial noise in pulses generated at the magnetic sensor 132. Therefore, it is preferable that the plurality of teeth 210 are configured in a resolution of about 3 degrees and, more specifically, that the distance between adjacent teeth of the plurality of teeth 210 is about 14 mm.

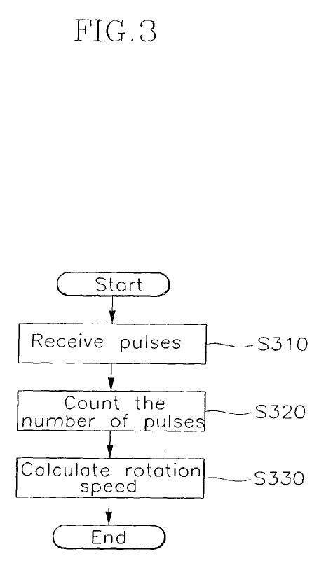

Referring to FIG. 3, to calculate rotation speed of the IGS 120, according to a preferred embodiment of the present invention, the control unit 160 receives pulses sequentially from the magnetic sensor 132 for a predetermined period (S310), and then counts the number of the received pulses (S320). Subsequently, the control unit 160 calculates the rotation speed of the IGS 120 on the basis of a value obtained by dividing the number of the received pulses by the predetermined period (S330). In a preferred embodiment, the value obtained at step S330 is in “pulses per second” units, but this value can be converted to a variety of units of rotational speed.

The above-explained method for calculating rotation speed of the IGS 120 is programmed and implemented in the control unit 160.

According to a preferred embodiment of the present invention, the mechanism for starting an engine and generating electricity is simplified over the prior art where a starter motor and an electric generator are separately equipped. Furthermore, rotation speed of the motor-generator unit (i.e., the engine speed) can be precisely determined, which enables precise control of the engine and the motor-generator unit.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims. Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. An electric system of a vehicle having an engine and a transmission, said electric system comprising:
a battery unit of a voltage higher than 14V;
a motor-generator unit, disposed between the engine and the transmission, for selectively functioning as a motor for driving the engine and as an electric generator driven by the engine; and
a control unit for recharging the battery unit by controlling output electric power of the motor-generator unit and for driving the motor-generator unit with electric power of the battery unit.

2. The electric system of claim 1, wherein the battery unit further comprises a plurality of battery units, including at least one low-voltage battery unit and at least one high-voltage battery unit, and further wherein low-voltage electric components of the vehicle receive power substantially from the at least one low-voltage battery unit, and wherein high-voltage electric components of the vehicle receive power substantially from the at least one high-voltage battery unit.

3. The electric system of claim 1, wherein said motor-generator unit comprises:
a stator fixed to the engine body; and
a rotor fixed to at least one of a crankshaft of the engine and an input rotating element of the transmission.

4. The electric system of claim 3, wherein the transmission is an automatic transmission equipped with a torque converter, and the input rotating element of the transmission is the torque converter.

5. The electric system of claim 3, further comprising:
a toothed wheel having a plurality of teeth and rotating with the rotor; and
a magnetic sensor, fixed at a stationary portion of at least one of the engine and the transmission, for generating pulse signals corresponding to rotation of the toothed wheel,
wherein the control unit calculates rotation speed of the rotor based at least in part on signals from the magnetic sensor.

6. The electric system of claim 5, wherein said plurality of teeth are formed on an exterior circumference of the toothed wheel, and the magnetic sensor is disposed to the exterior of said plurality of teeth with a predetermined gap therebetween.

7. The electric system of claim 5, wherein the transmission is an automatic transmission equipped with a torque converter, and the toothed wheel is disposed at a side of the torque converter toward the motor-generator unit.

8. The electric system of claim 5, wherein said plurality of teeth are configured in a resolution of approximately 3 degrees.

9. The electric system of claim 5, wherein a distance between adjacent teeth of said plurality of teeth is approximately 14 mm.

10. The electric system of claim 5, wherein said control unit counts a number of pulses sequentially received from the magnetic sensor for a predetermined period, and calculates a rotation speed of the motor-generator unit based at least in part on a value obtained by dividing the number of the received pulses by the predetermined period.

11. A method for determining the rotational speed of a motor in a vehicle, the method comprising:
driving a motor that rotates a rotor, the rotor including a toothed wheel having a plurality of teeth;
generating pulses by magnetically sensing rotation of the plurality of teeth of the toothed wheel with a magnetic sensor, the magnetic sensor being fixed at a stationary portion of at least one of the engine and a transmission;
calculating rotational speed of the motor, in a control unit, based at least part on the pulses from the magnetic sensor.

12. The method of claim 11, wherein the calculating rotational speed of the motor further comprises:
counting a number of pulses sequentially received from the magnetic sensor for a predetermined period; and
calculating a rotation speed of the motor based at least in part on a value obtained by dividing the number of the received pulses by the predetermined period.

13. The method of claim 11, wherein the transmission is an automatic transmission equipped with a torque converter, and the toothed wheel is disposed at a side of the torque converter toward the motor.

14. The method of claim 11, wherein said plurality of teeth are configured in a resolution of approximately 3 degrees.

15. The method of claim 11, wherein a distance between adjacent teeth of said plurality of teeth is approximately 14 mm.
